(19) United States
(12) Patent Application Publication
(10) Pub. No.: US 2012/0187344 A1
(43) Pub. Date: Jul. 26, 2012

(54) ENVIRONMENTAL ANTI-CORROSIVE ADDITIVES BASED ON POLY(ALKYLTHIOPHENE ACETATES) EASILY DISPERSIBLE IN PRIMING PAINTS FOR METAL SURFACES

(76) Inventors: Elaine Armelin Diggroc, Barcelona (ES); Carlos Alemán Llansó, Barcelona (ES); José Ignacio Iribarren Laco, Barcelona (ES); Francisco Liesa Mestres, Barcelona (ES); Francesc Estrany Coda, Barcelona (ES)

(21) Appl. No.: 13/138,925

(22) PCT Filed: Dec. 14, 2010
(86) PCT No.: PCT/ES2010/070820

§ 371 Date: Apr. 13, 2012

(51) Int. Cl. C09K 3/00; C09D 141/00

(52) U.S. Cl. 252/395; 524/547

(57) ABSTRACT

The present invention relates to poly[2,2′-(3-alkyl-acetate)thiophene] polythiophenes of linear C₁-C₁₂ alkyls of formula (I) which are easily dispersible in alkyd and epoxy type paints, and the addition of 1% of the electroconductive polymer allows the use thereof as anti-corrosive additives and as anti-corrosion microparticles of regulatable properties. The addition of 1% of electroconductive poly[2,2′-(3-methylacetate)thiophene] (PTE) polymer in the alkyd and epoxy priming paint substantially improves the adherence, blistering and resistance to corrosion properties of steel, especially in marine and industrial environments, even with performances better than other polyaniline-based conductive polymers.

The substitution of zinc and its derivatives with the electroconductive poly[2,2′-(3-alkyl-acetate)thiophene] (PTE) polymers in anti-corrosive epoxy and alkyd priming paints is technologically viable and, as a consequence, reduces the aggressive effect caused by these transition metals on the environment.

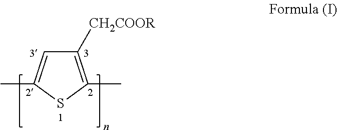

The present invention relates to the use of electroconductive polymers easily dispersible in organic solvents as corrosion inhibitors in paints applied as primers to prevent steel corrosion, and to the development of anti-corrosion microparticles.

In particular the invention relates to the use of poly[2,2′-(3-alkyl-acetate)thiophene] of linear C₁-C₁₂ alkyls for the substitution of zinc and its compounds, and of the additives containing transition metals generally used as additives in the formulation of anti-corrosive paints the toxic action of which on aquatic life is known.

### OBJECT OF THE INVENTION

The object of the present invention is to obtain anti-corrosive additives of low environmental impact based on poly[2,2′-(3-alkyl-acetate)thiophene] polythiophenes of the linear C₁-C₁₂ alkyls, easily dispersible in alkyd and epoxy type paints for marine and industrial environments; and to obtain anti-corrosive microparticles with well-controlled electrochemical and electrical properties.

A second object of the present invention is to provide the complete of partial substitution, with poly[2,2′-(3-alkyl-acetate)thiophene] polythiophenes, of zinc and its derivatives, and of the additives containing transition metals, all of them generally used as additives in the formulation of anti-corrosive epoxy and alkyd priming paints.

### STATE OF THE ART

One of the ways for protecting metals from corrosion consists of using anti-corrosive priming paints. There is a wide variety of paints on the market: epoxy, alkyd, among others, for marine protection and for industrial use. Interest in using organic electroconductive compounds as anti-corrosive additives has recently been evoked.

Polyaniline is one of the most used electroconductive polymers today in protection against corrosion due to its properties: high electric conductivity; it presents a color change at different voltages which indicates whether or not the polymer is doped and in what conditions, the doping process is reversible, it further has high stability and resistance to air and heat. Another particularity and advantage of this polymer resides in the fact that it can be presented different reduction-oxidation (redox) states.

The interest in polythiophenes is based on two significant properties: it is a material which can be handled more easily because it is less sensitive to oxygen; its environmental stability is one of the highest; it allows obtaining polymers soluble in organic or aqueous solvents through substituted monomers, in addition to having a lower oxidation potential than polyaniline.

Document WO2004016698A1 describes a corrosion resistant paint for metal surfaces which contains an organometallic film forming agent and an additive, wherein the additive would be an electroconductive polymer such as polyacetylene, polypyrrole, polythiophene, poly-(p-phenylene) or polyaniline. However, the document does not specifically mention the polythiophene derivative that could be used.

In the soluble form thereof, patent application JP2008066064 describes a water-based paint which contains a polymer made up of polycationic polythiophene and a polyanion made up of 0.5-1.5% by weight repetition units expressed by the general formula. Patent JP2006302561 describes a water-based paint which comprises a polycationic polythiophene and a polyanion at a concentration of 0.5-1.5%. Likewise, U.S. Pat. No. 5,766,515 relates to a water soluble polythiophene for obtaining an electroconductive coating. Ocampo et al. (Progress in Organic Coatings, 2005, 53, 217-224) describe the use of an electroconductive polymer, the regioregular poly(3-decylthiophene-2,5-diyl), and the resistance obtained against marine corrosion after the addition of 0.2% by weight of the polymer to several paints. However, the commercialization of these compounds as anti-corrosive additives for large amounts of marine and industrial paints is limited due to the high production cost thereof.

U.S. Pat. No. 6,060,116 claims the use of a particulate powder which comprises a thermoplastic polymer core coated with 5-30% of an electroconductive polymer based on polyaniline in the formulation of paints with the aid of a film forming matrix in which said particulate powder is dispersed. Patent US20040005464 describes an anti-corrosive paint for steels which uses polyaniline as an anti-corrosive pigment at concentrations which may range from 3 to 49% by weight. They assert that the paint has an excellent anti-corrosive effect, pigment duration and coating durability. The authors indicate that the stability of the pigment and of the coating is due to the fact that the additive is in the electroconductive state dispersed in the paint, and that said state in the formulation is stable over time.

In summary, it must be highlighted that references claiming the use of different electroconductive polythiophenes dispersed in anti-corrosive paints, distinguishing the individual monomers forming the repetition units thereof, are virtually not found.

The present invention thus fulfills the existing need in the application of more easily dispersible polythiophenes with predictable and regulatable properties as anti-corrosive paint additives. Another practical matter is the low concentration of only 0.3 to 1.5% by weight of the polythiophene needed for an effective protection of the formulations of epoxy and alkyd type marine and industrial paints. Therefore, the present invention represents significant progress for the substitution of the high amounts of zinc or other inorganic additives generally used (80-95% in zinc-rich paints, i.e., the so-called high performance marine paints), reducing the aggressive impact of said additives on the environment.

### DESCRIPTION OF THE INVENTION

### Preparation of poly[2,2′-(3-methylacetate)thiophene]

Poly[2,2′-(3-alkyl-acetate)thiophene] is synthesized according to the method of oxidative polymerization using iron (III) chloride as an oxidizing agent as indicated in the reference Kim et al. [Macromolecules 1999, 32, 3964].

a) The first step is an esterification reaction to convert the starting acid monomer into the ester monomer. The liquid ester (TE) monomer is obtained from the thiophene acid (TA) monomer. This reaction protects the acid group for the subsequent step of polymerization.

b) In the following step of polymerization, the thiophene ester (TE) monomer is oxidized with iron chloride in the presence of chloroform at 0° C. for 24 h. The thiophene ester polymer (PTE) is obtained with a yield of 60%.

The general synthesis scheme for obtaining a poly[2,2′-(3-alkyl-acetate)thiophene] doped with chloride ions (PTE) and subsequently with DBSA (PTE/DBSA), is illustrated below.

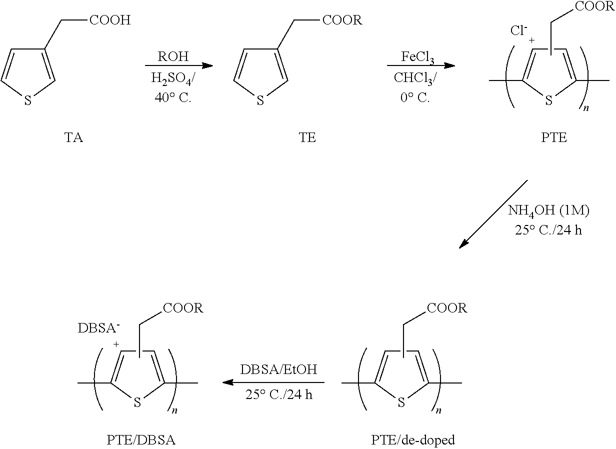

### Wherein:

The R group is a linear chain alkyl group with a number of carbons ranging from C₁-C₁₂.

The electron-donating dopants can be: Cl⁻ (chloride ions), DBSA (dodecylbenzenesulfonic acid), PSSA (poly(4-styrenesulfonic) acid), TSA (toluenesulfonic acid), CSA (camphorsulfonic acid), or NSA (beta-naphthalenesulfonic acid).

The electroconductive polymer, polythiophene ester with good solubility properties and with a chain partially doped with chloride ions or with acidic organic molecules is first obtained by this synthesis pathway.

Characterizing the poly[2,2′-(3-methylacetate)thiophene]:

The synthesized PTE has been characterized by infrared spectroscopy techniques (FTIR), thermogravimetric analysis (TGA), gel permeation chromatography (GPC) and solubility properties in different solvents.

FTIR (in cm⁻¹): 2998 (C—H, position 3′ Formula (I)), 1732 (C═O, ester), 1432 and 1325 (CH₂, CH₃), 1193 and 1163 (C—S, C—O), 844 (C—H, position 3′ Formula (I)), 743 (aromatic ring), 627 (C—S). The absence of bands at 790 cm⁻¹ indicating complete polymerization in positions 2 and 2′ of formula (I).

TGA: T_{d,0}=260° C., T_{d,24%}=382° C., Weight remaining at 800° C.=41.4%

GPC (m hexafluoroisopropanol): M_{w}=36524 g·mol⁻¹, Mₙ=24365 g·mol⁻¹

Solubility (at 25° C.): soluble in chloroform, dichloromethane, tetrahydrofuran, dimethylsulfoxide, dimethylformamide, trifluoroacetic acid, cyclohexanone and ortho-chlorobenzene; partially soluble in acetone; dispersible in xylene; insoluble in water at neutral or basic pH, in alcohols such as methanol or ethanol, toluene, hexane, acetonitrile or diethyl ether.

### Commercial Samples of Polyaniline:

In the present invention, two forms of polyaniline have been studied as anti-corrosive additives in priming paints for the purpose of comparing with the poly[2,2′-(3-methylacetate)thiophene] object of the present invention. The materials were acquired from Sigma-Aldrich Co. and they correspond to the products with reference to the Aldrich catalog:

Polyaniline emeraldine base, PANI-EB; Product number: 476706; form: solid powder; color: dark green; average molecular weight: M_{w} approx. 10,000.

Polyaniline emeraldine salt, PANI-ES; Product number: 650013; form: liquid 2-5% by weight (dispersion in xylene); boiling point: 116° C.; ignition point: 23° C.; density: 0.9-0.95 g/ml (at 25° C.).

### Characterizing the Polyanilines:

The commercial polyanilines were characterized in laboratories by infrared spectroscopy before use.

FTIR (in cm⁻¹): PAni-ES/DBSA: 3238 (—NH.+), 2918 and 2844 (C—H, dopant), 1555 (C═C, benzenoid form), 1449 (CH₂, dopant), 1290 and 1230 (C—N, C═N), 1100-900 (—SO₃H, dopant), 748 (aromatic ring). PAni-EB: 3400-3100 (—NH—), 3036 (C—H, aromatic), 1592 (C═C, quinoid form), 1495 (C═C, benzenoid form), 1294 and 1221 (C—N, C═N), 1161, 1105 and 829 (C—H, aromatic), 748 (aromatic ring).

### Description of the Epoxy and Alkyd Formulations:

A bicomponent epoxy-based priming paint comprising the following was prepared in the laboratory: Part A: 20% by weight (% weight) of epoxy resin with an equivalent weight EEW of 450-500), 46% by weight of pigments, 3% by weight of additives and 18% by weight of organic solvents. Part B: 12% by weight of polyaminoamide as hardener. The epoxy/amine ratio is 1.4-1.6 and the PVC/CPVC ratio (Pigment volume concentration/Critical pigment volume concentration ratio) was maintained at 0.65-0.70.

An alkyd-based priming paint comprising the following was prepared in the laboratory: 30% by weight of an alkyd resin modified with phenolic resin, 46% by weight of pigments, 4% by weight of additives and 20% by weight of organic solvents.

Three bicomponent epoxy formulations were prepared in total, one comprising 10% of zinc phosphate as anti-corrosive additive, another substituting the 10% of zinc phosphate with 0.3% by weight of PAni-EB and another substituting the zinc phosphate with 1% of poly[2,2′-(3-methylacetate)thiophene] (PTE). In the case of the alkyd paint all the anti-corrosive additives or pigments mentioned for the case of the epoxy formulations plus 1% of the commercial PAni-ES have been tested. Therefore, 7 different formulations described in detailed in the “Preferred Embodiments” section were prepared in total.

### Description of the Tests for Evaluating the Anti-Corrosive Properties:

Cold-rolled steel specimens of low carbon content corresponding to the DIN CK15 (AISI/SAE 1015) Standard were used. The metal surface was previously cleaned with a degreasant and the substrate was mechanically stripped according to UNE-IN-ISO 8504 Standard (Preparation of steel substrates before application of paints and related products—surface preparation methods). The dimensions of the specimens are 120×40 and thickness of 2 mm, with a hole of 6.5 mm in diameter for securing the parts. Once painted by immersion or with a spray gun and dried, the edges and the hole were reinforced with a commercial epoxy paint called Hempadur 45182 (Paints Hempel S.A.) to prevent corrosion in these areas.

The accelerated corrosion tests and the adhesion tests of the specimens painted with the epoxy and alkyd paints were performed in two different ways: (i) with a patented robot (Patent P-200500895/8: Brazo Mecánico para Realizar Ensayos de Corrosión Acelerados-Mechanical Arm for Performing Accelerated Corrosion Tests) submerging the sheets in the corrosive medium, performing the specimen immersion, run-off, drying and cooling cycles; and (ii) subjecting the specimens to a salt cloud chamber. All the tests were performed following the methods described in the: ASTM D1654 (Standard Test Method for Evaluation of Painted or Coated Specimens Subjected to Corrosive Environments), ASTM D714 (Standard Test Method for Evaluating Degree of Blistering of Paints), ASTM B117 (Standard Practice for Operating Salt Spray Fog Apparatus) Standards and UNE-IN-ISO 4624 Standard (Paints and varnishes: Pull-off adhesion test).

The resistances to the corrosion of the priming paints with zinc phosphate and the paints modified by addition of the electroconductive polymers have been compared.

### DRAWINGS

The object of the invention will now be described from the preferred embodiments which will be better understood based on the following accompanying drawings, in which:

FIG. 1 shows the evolution of the corrosion (area of failure, %) of the epoxy coatings of the preferred embodiments No. 1-3 in marine medium.

FIG. 2 shows the evolution of the corrosion (area of failure, %) of the alkyd coatings of the preferred embodiments No. 4-7 in marine medium.

FIG. 3 shows the comparative photos of the specimens coated with epoxy paint and subjected to accelerated corrosion tests in marine medium (C: control, D: after 960 h). The numbering corresponds to the preferred embodiments.

FIG. 4 shows the comparative photos of the specimens coated with alkyd paint and subjected to accelerated corrosion tests in marine medium (C: control, D: after 480 h). The numbering corresponds to the preferred embodiments.

### DESCRIPTION OF THE PREFERRED EMBODIMENTS

### Embodiment No. 1

### Bicomponent Epoxy Priming Paint with 10% of Zinc Phosphate

Preparation

20% by weight of epoxy resin (Epikote 1001X75, Resolution Europe-Brenntag), 5% by weight of titanium dioxide (white oxined, Europigments), 10% by weight of zinc phosphate (Nubiola), 20% by weight of barite (Barium sulfate, Comindex S.A.), 12% by weight of talc (Talco Industrial FF, T3Quimica), 0.23% by weight of Aerosil 200 (Degussa AG), 1% by weight of Antiterra U (BYK Chemie), 0.7% by weight of BYK-500 and BYK-525 (BYK Chemie) and 19% by weight of a mixture of solvents containing butanol, methyl-isobutyl-ketone and xylene (Panreac Quimica); the foregoing were mixed and dispersed at 15000 rpm for 15 minutes with a Dispermat disperser model TU APS 250. After the mixing and dispersion, the formulation is ground in a batch mill provided with zirconium oxide balls to reduce the particle size below 50 micrometers. This process led to obtaining component A of the epoxy paint. 12% by weight of component B, a polyaminoamide (Crayamid 195×60, Cray Valley) was then added to component A and was stirred for 5 minutes with the disperser. After an induction time of 20-30 minutes, the pre-treated steel specimens are painted by immersion and dried at room temperature for a week.

### Embodiment No. 2

### Bicomponent Epoxy Priming Paint with 1% of Poly[2,2′-(3-Methylacetate)Thiophene]

Preparation

20% by weight of epoxy resin (Epikote 1001X75, Resolution Europe-Brenntag), 5% by weight of titanium dioxide (white oxined, Europigments), 1% by weight of poly[2,2′-(3-methylacetate)thiophene] (PTE), 20% by weight of barite (barium sulfate, Comindex S.A.), 12% by weight of talc (Talco Industrial FF, T3Quimica), 0.23% by weight of Aerosil 200 (Degussa AG), 1% by weight of Antiterra U (BYK Chemie), 0.7% by weight of BYK-500 and BYK-525 (BYK Chemie) and 19% by weight of a mixture of solvents containing butanol, methyl-isobutyl-ketone and xylene (Panreac Quimica); the foregoing were mixed and dispersed at 15000 rpm for 15 minutes with a Dispermat disperser model TU APS 250. After the mixing and dispersion, the formulation is ground in a batch mill provided with zirconium oxide balls to reduce the particle size below 50 micrometers.

### Embodiment No. 3

### Bicomponent Epoxy Priming Paint with 0.3% of PAni-EB

Preparation

19% by weight of epoxy resin (Epikote 1001X75, Resolution Europe-Brenntag), 7% by weight of titanium dioxide (white oxined, Europigments), 24% by weight of barite (barium sulfate, Comindex S.A.), 12% by weight of talc (Talco Industrial FF, T3Quimica), 0.27% by weight of Aerosil 200 (Degussa AG), 1% by weight of Antiterra U (BYK Chemie), 1% by weight of BYK-500 and BYK-525 (BYK Chemie) and 20% by weight of a mixture of solvents containing butanol, methyl-isobutyl-ketone and xylene (Panreac Quimica); the foregoing were mixed and dispersed at 15000 rpm for 15 minutes with a Dispermat disperser model TU APS 250. During the step of dispersion and stirring, 0.3% by weight of PAni-EB was added very slowly due to its great tendency to agglomerate when coming into contact with a liquid medium. After mixing and dispersing all the reagents, the formulation is ground in a batch mill provided with zirconium oxide balls to reduce the particle size below 50 micrometers.

### Embodiment No. 4

### Alkyd Priming Paint with 10% of Zinc Phosphate

Preparation

11% by weight of a phenolic alkyd resin (Synolac 7503×60, Cray Valley), 2% by weight of Tixatrol ST at 15% in xylene (Tixotropant Rheox, Zeus Quimica), 10% by weight of zinc phosphate (Nubiola), 9% by weight of titanium dioxide (white oxined, Europigments), 0.25% by weight of Antiterra U (BYK Chemie), 13% by weight of talc (Talco Industrial FF, T3Quimica), 17.5% by weight of calcium carbonate (Albarex, Campi & Jove), and 3.7% by weight of xylene (Panreac Quimica) were dispersed and mixed with a Dispermat disperser model TU APS 250. After a pre-dispersion, the rest of the alkyd resin (18.4% by weight), 0.17% by weight of cobalt (Panreac Quimica), and 19.8% by weight of a mixture of solvents containing butanol, methyl-isobutyl-ketone and xylene (Panreac Quimica) was added. All the reagents are stirred at 15000 rpm for 15 minutes with a Dispermat disperser model TU APS 250 and ground with a batch mill provided with zirconium oxide balls to reduce the particle size below 50 micrometers.

### Embodiment No. 5

### Alkyd Priming Paint with 1% of Poly[2,2′-(3-Methylacetate)Thiophene]

Preparation

The anti-corrosive paint with 1% by weight of poly[2,2′-(3-methylacetate)thiophene] was prepared with the same method described in Embodiment No. 4, substituting the 10% by weight of zinc phosphate with 1% by weight of the electroconductive polymer. The PTE was added in the final reagent dispersion phase in the form of liquid dispersion according to the method of addition described in the “Addition of the electroconductive polymers” section.

### Embodiment No. 6

### Alkyd Priming Paint with 0.3% of PAni-EB

Preparation

The anti-corrosive paint with 0.3% of commercial PAni-EB was prepared with the same method described in. Embodiment No. 4, substituting the 10% by weight of zinc phosphate with 0.3% by weight of the electroconductive polymer. The PAni-EB is solid and was added very slowly in the initial reagent dispersion phase according to the method of addition described in the “Addition of the electroconductive polymers” section.

### Embodiment No. 7

### Alkyd Priming Paint with 1% of PAni-ES

Preparation

The anti-corrosive paint with 1% of commercial PAni-ES was prepared with the same method described in Embodiment No. 4, with the exception that the 10% by weight of zinc phosphate was substituted with 1% by weight of the electroconductive polymer. The PAni-ES is a solid finely dispersed in xylene and is added in the initial reagent dispersion phase, presenting excellent dispersion with the alkyd resin.

### Addition of the Electroconductive Polymers

### Method of Addition of the Poly[2,2′-(3-Methylacetate)Thiophene] in the Anti-Corrosive Formulations

The method described below corresponds to embodiments No. 2 and No. 5. The electroconductive polymers poly(alkyl thiophene acetates), and the representative polymer of this class, the polymer poly[2,2′-(3-methylacetate)thiophene] (PTE), object of the present invention, is in solid form. To incorporate the same in the anti-corrosive formulations it is necessary to, first, reduce their particle size with the aid of an ultrasonicator (Bandelin Sonoplus model HD 2200 equipped with a cylindrical tip of 2 mm in diameter and a frequency of 20 kHz) and, second, disperse the microparticles in a suitable solvent. In the case of the PTE, sound waves are applied thereon until reaching a particle size of 80-100 nm, 1 g of the material is dispersed in 2-3 mL of chloroform and filtered to remove any non-dissolved particle. After the dispersion with chloroform, sound waves are applied again on the mixture for 2 min and it is immediately added to the desired paint formulation. The polymer PTE, contrary to what happens with the PAni, has no tendency to be agglomerated, but it is important to reduce their particle size so that they are well dispersed in the liquid medium of the paint. The polymer PTE acts as anti-corrosive microparticles and as pigment, providing a yellow color the final paint.

### Method of Addition of the PAni-EB in the Anti-Corrosive Formulations

The method described below corresponds to embodiments No. 3 and No. 6. Commercial PAni-EB is in solid form. To incorporate the same in the anti-corrosive formulations it was necessary to reduce its particle size with the aid of an ultrasonicator (Bandelin Sonoplus model HD 2200) until reaching a particle size of 80-100 nm. The fine powder is added very slowly to the paint formulation in the reagent mixing and dispersion process, because it has a high tendency to agglomerate when coming into contact with the solvent. For this reason, the grinding process of the formulation is more exhaustive than in the case of the polymer PTE or the PAni-ES. The polymer PAni-EB acts as anti-corrosive additive and as pigment, providing a lilac or bluish color to the final paint.

### Method of Addition of the PAni-ES in the Anti-Corrosive Formulations

This method refers to embodiment No. 7. Commercial PAni-ES is in liquid form and is a dispersion of 2-3% by weight of the electroconductive polymer in xylene. To incorporate thereof in the anti-corrosive formulations no prior treatment is necessary and it is added directly in the additive and pigment adding process. The polymer PAni-ES acts as anti-corrosive additive and as pigment, providing a greenish color to the final paint.

Average Thickness of the Coatings Obtained after a Layer of Priming Paint

The metal specimens were coated with the paints of embodiments No. 1-7 and were left to dry for 7 days before subjecting them to the accelerated corrosion tests. Their thickness was measured with a thickness meter model Easy-Check FN (Neurtek S.A. brand), taking the average of six values of each face. The results are expressed in Table 1.

TABLE 1
Compositions and thicknesses of the paints of the preferred embodiments

| | Embodiment | | | | | | |
|---|---|---|---|---|---|---|---|
| | No. 1 | No. 2 | No. 3 | No. 4 | No. 5 | No. 6 | No. 7 |
| Base resin | Epoxy | Epoxy | Epoxy | Alkyd | Alkyd | Alkyd | Alkyd |
| Anti-corrosive | Zinc | PTE | PAni-EB | Zinc | PTE | PAni-EB | PAni-ES |
| additive | phosphate | | | phosphate | | | |
| Concentration | 10% by | 1% by | 0.3% by | 10% by | 1% by | 0.3% by | 1% by |
| | weight | weight | weight | weight | weight | weight | weight |
| Average | 155 ± 10 | 98 ± 15 | 90 ± 20 | 70 ± 5 | 70 ± 11 | 49 ± 7 | 52 ± 9 |
| thickness | | | | | | | |
| (μm) | | | | | | | |

### Test Mediums

The preferred embodiments of the present invention were carried out in the following mediums reproducing the conditions of:

Marine environment (for embodiments No. 1-7): The medium is a 3.5% by weight NaCl solution and the pH is 6.5-6.6. The NaCl solution represents the corrosion conditions in salt atmospheres, i.e., to which the steels are subjected to in environments close to the sea or submerged therein.

Salt fog environment (for embodiments No. 1-3): The medium is a 5% by weight NaCl solution, the pH is regulated between 6.5-6.6 and the temperature is 35±1° C. In this case a standard chamber which atomizes the salt solution is used, providing a salt fog environment on the painted sheets (ASTM B117 Standard).

Industrial environment (for embodiments No. 4-7): The medium is a 3% by weight NaHSO₃ solution and the pH is 3.5. The NaHSO₃ solution represents an acid medium, i.e., acidity conditions to which certain metal structures in industrial areas can be subjected to.

### Operations Performed

a) Pre-treatment of the steel sheets: a mechanical stripping device was used according to UNE-EN-ISO 8504 Standard.
b) Treatment before painting: a compressed air jet is applied immediately before painting to remove any trace of powder coming from the stripping.
c) Painting process: a single layer of paint is applied with air spray (in the case of alkyd paints) or by immersion (in the case of epoxy paints), the average thickness of the layer of dry paint in these circumstances are shown in Table 1.

### Methods of Evaluation of the Corrosion

The evaluation of the corrosion in the specimens to be tested is performed by the methods:

Scrape method: according to the ASTM D1654 Standard which allows evaluating the adhesion of the paint in the scrape and the extension of the degree of corrosion therein.

Adherence method: according to ASTM D1654 Standard and UNE-EN-ISO 4624 Standard which allows evaluating the strength whereby the paint is adhered to the metal substrate over time.

Blistering method: according to the ASTM D714 Standard which allows evaluating the formation of blisters in paints subjected to corrosive environments by means of comparing with standards.

### Corrosion Tests of the Specimens of Embodiments No. 1-7 in Marine Environment and in Industrial Environment

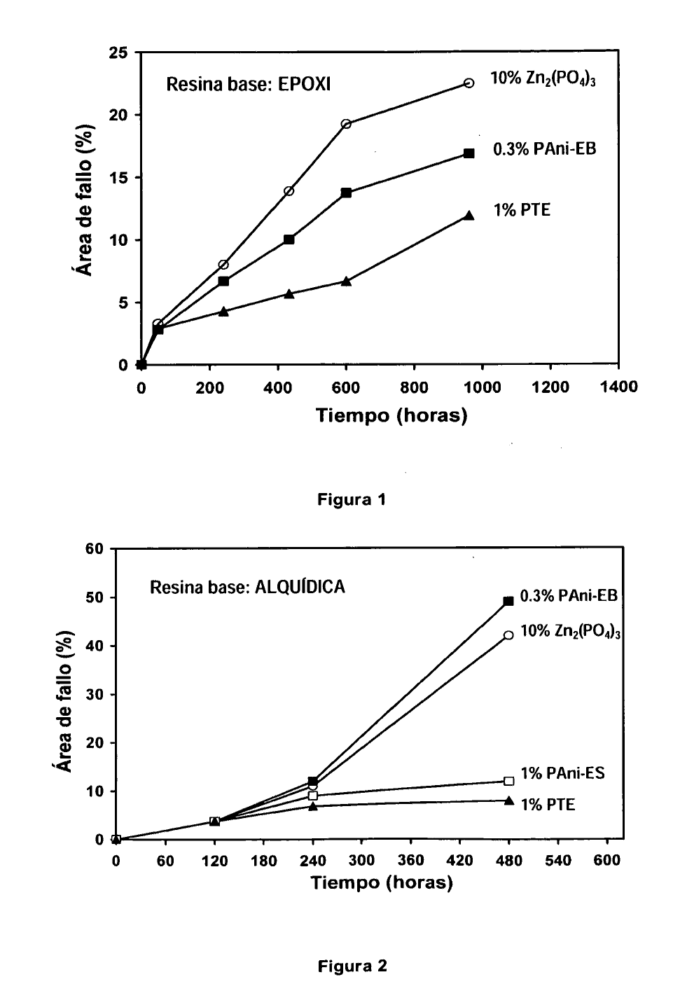

The main results obtained from the accelerated corrosion tests to check the efficiency and applicability of the anti-corrosive additives object of the present invention are described below. The results of the protective coating physical properties tests are summarized in Tables 2 and 3 and in FIGS. 1 and 2.

### Adherence Tests [ASTM D1654 Standard or UNE-EN-ISO 4624 Standard]

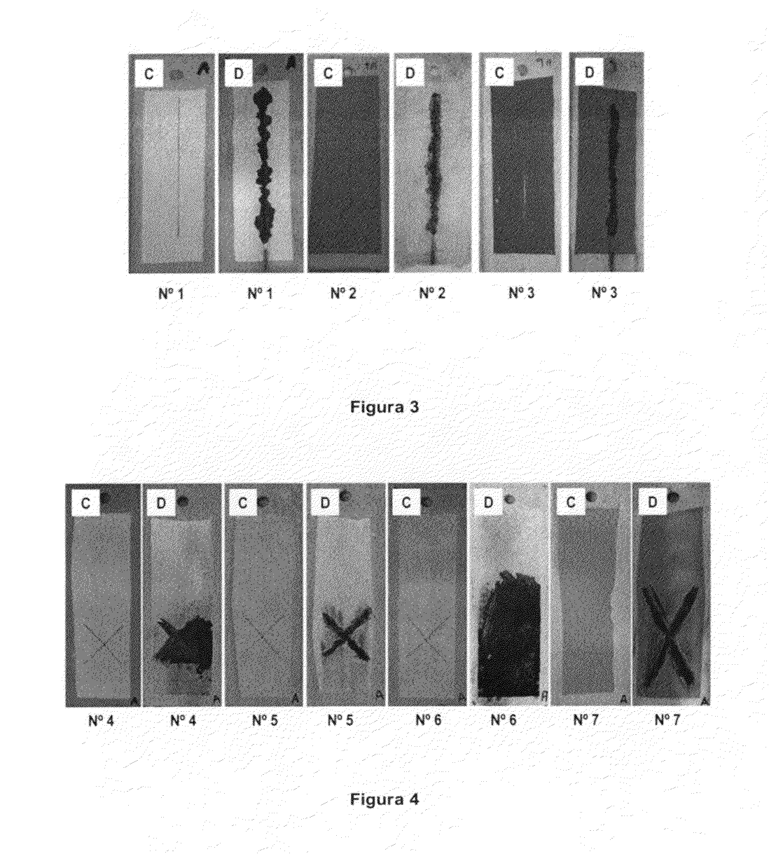

The greater the adherence between the coating and the substrate, the longer the metal will be protected from the corrosive medium surrounding it. In marine environment, the excellent adherence provided by the additives PTE and PAM-EB [FIG. 3] stands out; whereas in industrial environment the improved results are obtained with the additives PTE and PAM-ES [FIG. 4].

### Corrosion in the Scrape [ASTM D1654 Standard]

Poly[2,2′-(3-methylacetate)thiophene] (PTE) shows a high resistance to corrosion, even after the appearance of defects and scratches in the coating due to its excellent redox property and conductive properties. The polymer conductor PTE shows a protective behaviour (non-extension of the rust from the scrape) even with the steel sheet exposed and subjected to 960 h of accelerated corrosion test in marine environment [FIG. 1]. Compared with the other additives, the percentage of corroded area in the case of the PTE is nil or is very low [FIGS. 1 and 2]. Evaluation of the blistering [ASTM D714 Standard]

Paint No. 2 made up of epoxy base with anti-corrosive additive PTE, with excellent resistance to the appearance of blisters in the area of the scrape or below the coating, even after 40 days of test, confirming its high adherence and metal substrate guarding property, stands out. This result is attributed to the ease for dispersing this additive contrasting, on the other hand, with the ease for forming agglomerates and, consequent increase of the porosity of the coating, provided by the polyanilines. Generally, the paints with conventional zinc phosphate-based anti-corrosive additive do not show resistance to the formation of blistering when they suffer mechanical damage (scratch, pores, among other defects).

### Adherence and Anti-Corrosive Properties of the Films of Epoxy Paint

Table 2 below shows the results obtained with the epoxy paints subjected to accelerated corrosion conditions.

TABLE 2
Comparison of the adherence and anti-corrosive properties of the
films of epoxy paint after 960 h of exposure to accelerated
corrosion conditions

| EMBODIMENT | | No. 1 | No. 2 | No. 3 |
|---|---|---|---|---|
| Corrosive medium | | NaCl | NaCl | NaCl |
| Adherence | D1654^{a)} | 4 | 5 | 5 |
| | ISO4624^{b)} | 85% B | 0% B | 0% B |
| | | 15% B/C | 100% B/C | 100% B/C |
| Corrosion^{c)} | Scrape | 6.5 | 5 | 4 |
| | (mm) | | | |
| | Corroded area | 22.5 | 11.9 | 16.8 |
| | (%) | | | |
| Blistering^{d)} | Scrape | 2 MD | 10 | 8 F |
| 3.5% NaCl | Surface | 10 | 10 | 6 F |
| (marine) | | | | |
| Blistering^{d)} | Scrape | 4 M | 10 | 2 M |
| 5% NaCl | Surface | 10 | 10 | 10 |
| (salt fog) | | | | |

^{a)}ASTM D1654: Method A, numerical scale from 0 to 10, with 10 corresponding to no sign of corrosion.
^{b)}UNE-IN-ISO 4624: B indicates cohesive fracture of the first layer of paint, B/C indicates adhesive fracture between the adhesive used to hold the dolly and the layer of paint.
^{c)}ASTM D1654: Method A, extension of the corrosion from the scrape in mm; Method B, percentage of corroded area below the coating and from the scrape corresponding to the accelerated corrosion tests in marine environment and salt fog environment.
^{d)}ASTM D714: The numbers refer to the size of the blisters wherein 6, 4 and 2 progressively represent larger blister sizes and 10 represents the non-appearance of blisters; whereas the letters refer to the density of blisters in the coating: D, dense; MD, medium dense; M, medium; F, low.
Adherence and anti-corrosive properties of the films of alkyd paint

Table 3 below show the results obtained with the alkyd paints subjected to accelerated corrosion conditions.

TABLE 3
Comparison of the adherence and anti-corrosive properties of the films of alkyd paint after 480 h
of exposure to accelerated corrosion conditions

| | | EMBODIMENT | | | | | | | |
|---|---|---|---|---|---|---|---|---|---|
| | | No. 4 | | No. 5 | | No. 6 | | No. 7 | |
| Corrosive medium | | NaCl | NaHSO₃ | NaCl | NaHSO₃ | NaCl | NaHSO₃ | NaCl | NaHSO₃ |
| Adherence | D1654^{a)} | 5-6 | 6 | 8-9 | 10 | 4-5 | 5 | 7-8 | 6-7 |
| | ISO4624^{b)} | 32% B | NA | 25% B | NA | NA | NA | NA | NA |
| | | 68% B/C | | 75% B/C | | | | | |
| Corrosion^{c)} | Scrape | 3 | 2.5 | 0.5 | 0 | 5 | 4 | 1 | 2 |
| | (mm) | | | | | | | | |
| | Corroded area | 42 | 22 | 8 | 0 | 49 | 23 | 12 | 14 |
| | (%) | | | | | | | | |
| Blistering^{d)} | Scrape | 4 MD | 2 MD | 8 F | 10 | 2 D | 6 M | 10 | 10 |
| | Surface | 4 MD | 10 | 10 | 10 | 2 D | 10 | 10 | 10 |

^{a)}ASTM D1654: Method A, numerical scale from 0 to 10 with 10 corresponding to no sign of corrosion.
^{b)}UNE-EN-ISO 4624: B indicates cohesive fracture of the first layer of paint, B/C indicates adhesive fracture between the adhesive used to hold the dolly and the layer of paint. The results refer to the specimens subjected to marine environment (NaCl 3.5%). NA = not available.
^{c)}ASTM D1654: Method A, extension of the corrosion from the scrape in mm; Method B, percentage of corroded area below the coating and from the scrape corresponding to the accelerated corrosion tests in marine environment and industrial environment (NaHSO₃).
^{d)}ASTM D714: The numbers refer to the size of the blisters wherein 6, 4 and 2 progressively represent larger blister sizes and 10 represents the non-appearance of blisters; whereas the letters refer to the density of blisters in the coating: D, dense; MD, medium dense; M, medium; F, low.

### Properties of the Poly[2,2′-(3-Alkyl-Acetate)Thiophene] (PTE) as Anti-Corrosive Additive

In summary, the polythiophenes poly[2,2′-(3-alkyl-acetate)thiophene] of the present invention have been shown as effective anti-corrosive additives as a result of the following properties:

The polythiophenes poly[2,2′-(3-alkyl-acetate)thiophene] of the normal C₁-C₁₂ alkyls are easily dispersible in alkyd and epoxy type paints, and the addition of 0.3-1.5% of the electroconductive polymer (PTE) allow the satisfactory use thereof as anti-corrosive additives and as anti-corrosion microparticles of regulatable properties.

The addition of 1% of electroconductive polymer poly[2,2′-(3-methylacetate)thiophene] (PTE) in the epoxy and alkyd priming paints substantially improves the adherence, blistering and resistance to corrosion properties of the steel both in marine medium and in industrial environment.

The substitution of the zinc and its compounds in the anti-corrosive epoxy and alkyd priming paints is possible due to the electroconductive polymers poly[2,2′-(3-alkyl-acetate)thiophene] (PTE) completely removing the aggressive effect of the zinc derivatives on the environment.

Having sufficiently described the invention as well as several preferred embodiments thereof, it merely remains to be added that it is possible to perform modifications in the composition and materials used thereof without departing from the scope of the same defined in the following claims.

1.-7. (canceled)

8. A method for using polythiophenes dispersible in organic solvents as anti-corrosive additives or pigments of alkyd and epoxy type priming paints for metal surfaces exposed to marine or industrial environments comprising polythiophenes of the poly[2,2′-(3-alkyl-acetate)thiophene] type of general formula (I), 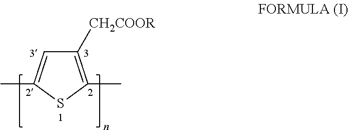
wherein R are linear chain alkyl groups from C₁-C₁₂.

9. The method according to claim 8, wherein in that said polythiophenes of general formula (I) are doped with electronegative organic agents of the dodecylbenzenesulfonic acid, DBSA; poly(4-styrenesulfonic) acid, PSSA; toluenesulfonic acid, TSA; camphorsulfonic acid, CSA; or beta-naphthalenesulfonic acid, NSA, type.

10. The method according to claim 8, characterized in that said polythiophenes of general formula (I), as they are synthesized by the method of oxidative polymerization with iron (III) chloride, are obtained in a controllable and reproducible manner, therefore the size of their particles is suitably reduced to anti-corrosion microparticles with regulatable physicochemical properties, wherein said anti-corrosion microparticles are conveniently dispersible in organic solvents.

11. The method according to claim 9, characterized in that said polythiophenes of general formula (I), as they are synthesized by the method of oxidative polymerization with iron (III) chloride, are obtained in a controllable and reproducible manner, therefore the size of their particles is suitably reduced to anti-corrosion microparticles with regulatable physicochemical properties, wherein said anti-corrosion microparticles are conveniently dispersible in organic solvents.

12. The method for using dispersible poly[2,2′-(3-alkyl-acetate)thiophene] polythiophenes for anti-corrosive additives or pigments of alkyd and epoxy type priming paints of claim 8, characterized in that said polythiophenes of general formula (I) are conveniently dispersed in volatile organic solvents, preferably dichloromethane or chloroform; and in non-volatile organic solvents, preferably in dimethylsulfoxide.

13. The method for using dispersible poly[2,2′-(3-alkyl-acetate)thiophene] polythiophenes for anti-corrosive additives or pigments of alkyd and epoxy type priming paints of claim 9, characterized in that said polythiophenes of general formula (I) are conveniently dispersed in volatile organic solvents, preferably dichloromethane or chloroform; and in non-volatile organic solvents, preferably in dimethylsulfoxide.

14. The method for using dispersible poly[2,2′-(3-alkyl-acetate)thiophene] polythiophenes for anti-corrosive additives or pigments of alkyd and epoxy type priming paints of claim 10, characterized in that said polythiophenes of general formula (I) are conveniently dispersed in volatile organic solvents, preferably dichloromethane or chloroform; and in non-volatile organic solvents, preferably in dimethylsulfoxide.

15. The method for using dispersible poly[2,2′-(3-alkyl-acetate)thiophene] polythiophenes for anti-corrosive additives or pigments of alkyd and epoxy type priming paints of claim 8, characterized in that said polythiophenes of general formula (I) provide high anti-corrosive properties when used in said alkyd and epoxy formulations at concentrations as low as 0.3-1.5% w/v.

16. The method for using dispersible poly[2,2′-(3-alkyl-acetate)thiophene] polythiophenes for anti-corrosive additives or pigments of alkyd and epoxy type priming paints of claim 9, characterized in that said polythiophenes of general formula (I) provide high anti-corrosive properties when used in said alkyd and epoxy formulations at concentrations as low as 0.3-1.5% w/v.

17. The method for using dispersible poly[2,2′-(3-alkyl-acetate)thiophene] polythiophenes for anti-corrosive additives or pigments of alkyd and epoxy type priming paints of claim 10, characterized in that said polythiophenes of general formula (I) provide high anti-corrosive properties when used in said alkyd and epoxy formulations at concentrations as low as 0.3-1.5% w/v.

18. The method for using dispersible poly[2,2′-(3-alkyl-acetate)thiophene] polythiophenes for anti-corrosive additives or pigments of alkyd and epoxy type priming paints of claim 8, characterized in that when using in said alkyd and epoxy paints at concentrations of 0.3-1.5% w/v, they completely or partially substitute the electroconductive organic additives based on the polyaniline emeraldine base, PAni-EB, and on the polyaniline emeraldine salt, PAni-ES, used as anti-corrosive pigments of said paints.

19. The method for using dispersible poly[2,2′-(3-alkyl-acetate)thiophene] polythiophenes for anti-corrosive additives or pigments of alkyd and epoxy type priming paints of claim 9, characterized in that when using in said alkyd and epoxy paints at concentrations of 0.3-1.5% w/v, they completely or partially substitute the electroconductive organic additives based on the polyaniline emeraldine base, PAni-EB, and on the polyaniline emeraldine salt, PAni-ES, used as anti-corrosive pigments of said paints.

20. The method for using dispersible poly[2,2′-(3-alkyl-acetate)thiophene] polythiophenes for anti-corrosive additives or pigments of alkyd and epoxy type priming paints of claim 10, characterized in that when using in said alkyd and epoxy paints at concentrations of 0.3-1.5% w/v, they completely or partially substitute the electroconductive organic additives based on the polyaniline emeraldine base, PAni-EB, and on the polyaniline emeraldine salt, PAni-ES, used as anti-corrosive pigments of said paints.

21. The method for using dispersible poly[2,2′-(3-alkyl-acetate)thiophene] polythiophenes for anti-corrosive additives or pigments of alkyd and epoxy type priming paints of claim 12, characterized in that when using in said alkyd and epoxy paints at concentrations of 0.3-1.5% w/v, they completely or partially substitute the electroconductive organic additives based on the polyaniline emeraldine base, PAni-EB, and on the polyaniline emeraldine salt, PAni-ES, used as anti-corrosive pigments of said paints.

22. Reduction of environmental contamination by using the dispersible poly[2,2′-(3-alkyl-acetate)thiophene] polythiophenes of claim 8, characterized in that when using said poly[2,2′-(3-alkyl-acetate)thiophene] polythiophenes at concentrations of 0.3-1.5% w/v, they completely or partially replace the zinc phosphate and the microparticles of metallic zinc powders used in said anti-corrosive alkyd and epoxy paints.

23. Reduction of environmental contamination by using the dispersible poly[2,2′-(3-alkyl-acetate)thiophene] polythiophenes of claim 9, characterized in that when using said poly[2,2′-(3-alkyl-acetate)thiophene] polythiophenes at concentrations of 0.3-1.5% w/v, they completely or partially replace the zinc phosphate and the microparticles of metallic zinc powders used in said anti-corrosive alkyd and epoxy paints.

24. Reduction of environmental contamination by using the dispersible poly[2,2′-(3-alkyl-acetate)thiophene] polythiophenes of claim 10, characterized in that when using said poly[2,2′-(3-alkyl-acetate)thiophene] polythiophenes at concentrations of 0.3-1.5% w/v, they completely or partially replace the zinc phosphate and the microparticles of metallic zinc powders used in said anti-corrosive alkyd and epoxy paints.

25. Reduction of environmental contamination by using the dispersible poly[2,2′-(3-alkyl-acetate)thiophene] polythiophenes of claim 12, characterized in that when using said poly[2,2′-(3-alkyl-acetate)thiophene] polythiophenes at concentrations of 0.3-1.5% w/v, they completely or partially replace the zinc phosphate and the microparticles of metallic zinc powders used in said anti-corrosive alkyd and epoxy paints.
